(19) United States
(12) Patent Application Publication
(10) Pub. No.: US 2002/0038220 A1
(43) Pub. Date: Mar. 28, 2002

(54) Consignment quantity setting device and consignment quantity setting method for products used in call sales

(75) Inventor: Kenji Tsumura, Saga-ken (JP)

Correspondence Address: JORDAN AND HAMBURG LLP, 122 EAST 42ND STREET, SUITE 4000, NEW YORK, NY, 10168, US

(73) Assignee: Kentop Corporation, Saga-shi (JP)

(21) Appl. No.: 09/915,740

(22) Filed: Jul. 26, 2001

(30) Foreign Application Priority Data
Aug. 11, 2000 (JP) 2000-244547

(51) Int. Cl. G06F 17/60

(52) U.S. Cl. 705/1

(57) ABSTRACT

There are provided a consignment quantity setting device and a consignment quantity setting method for products used in call sales that enable an appropriate consignment quantity to be set without relying on the intuition and experience of the salesperson. A periodic factor index that shows a trend of an increasing or decreasing quantity of consumption of a product in each period is stored in advance in a storage means 12 and the quantity of the product consumed by each customer is input using an input means 11 and stored in the storage means 12. Average consumed quantity calculation means 13 acquires the quantity of the product consumed from the storage means 12, calculates the average quantity of the product consumed by all customers and stores it in the storage means 12. Consumption history index calculation means 14 acquires the quantity of the product consumed from the storage means 12, calculates a consumption history index showing the quantity of the product consumed in the past in each period and stores this in the storage means 12. A consignment quantity calculation means 15 acquires the average consumed quantity, the periodic factor index, and the consumption history index and calculates the quantity to be consigned for the current period relative to the quantity consigned for the previous period. The calculated quantity to be consigned for the current period is output using an output means 16.

### BACKGROUND OF THE INVENTION

1. Field of the Invention

The present invention relates to a consignment quantity setting device and a consignment quantity setting method for products used in call sales for setting the quantity of various types of products which are delivered and consigned to a customer in the field of call sales of medical supplies and various other products.

2. Description of the Related Art

In the field of call sales of medical supplies and the like, conventionally, a system is used in which a medicine chest containing several types of medicines having various beneficial effects is left to a customer. After an appropriate time has passed, a call sales operator (referred to below as a “salesperson”) visits the customer and receives payment from the customer for those medicines that the customer has used from the medicine chest and also replenishes the supplies of the used medicines.

In this type of system, what is known as the consigned medicine data, which comprises the medicinal items and numerical quantities thereof kept by the customer and used by the customer and the like, has conventionally been recorded in an account book known as an order estimate book. However, recently, methods of recording and management using computers have become increasingly widespread.

On the other hand, since the management of the types of medicines in the medicine chest kept by the customer has been entrusted to the salesperson who visits the customer, the various management tasks relating to the types of medicines, the numerical quantities thereof, the limits of the time they are left with the customer, and so on, have all been performed by the each salesperson. When he or she visits the customer, each salesperson sets the call cycle for calling on the customer and replenishes the used medicines according to various data relating to the customer which is based on the salesperson's experience.

When the medicines in the medicine chest have been used, the salesperson normally replenishes the used medicines by a factor of 2 to 3 times the quantity used. At this time, if the quantity used has increased compared to the quantity found to be used in the last visit, the medicines are replenished by an even greater quantity. If no medicines have been used, the quantity is reduced; however, even if no medicines have been used, the product maybe replenished by an increased or decreased quantity taking into account probable increases or decreases in future quantities to be used that are due to seasonal factors or the like.

Because call sales employ what is known as a “use-now-pay-later” business system (i.e. the customer pays later for the amount used), the maximum amount of sales possible for each call is the amount of the product that is left with the customer. Since a much larger stock is held in the field of call sales in comparison with other types of sales fields, if a surplus product is left with a customer, surplus purchases are generated, which tends to cause losses. Accordingly, to set the quantity of product to be left with a customer in order not to lose sales opportunities and to avoid the surplus stock largely depends on the salespersons' skill such as their experience and intuition.

### SUMMARY OF THE INVENTION

In the present invention, there are provided a consignment quantity setting device and a consignment quantity setting method for products used in call sales that enable an appropriate consignment quantity to be set without relying on the intuition and experience of the salesperson.

The product consignment quantity setting device of the present invention for setting a consignment quantity of a product that is delivered and consigned to a customer in the field of call sales comprises: means for inputting a quantity of a product that is consumed by a customer; first storage means for storing the input consumed quantity of the product and a consignment quantity of the product in each period; means for acquiring the consumed quantity of the product from the first storage means and calculating an average quantity of the product consumed by all customers; second storage means for storing the calculated average consumed quantity; third storage means for storing a periodic factor index showing a trend of increasing or decreasing quantity of the product consumed in each period; means for acquiring the consumed quantity of the product from the first storage means and calculating a consumption history index showing a quantity of the product which was consumed in each period in the past; fourth storage means for storing the calculated consumption history index; means for acquiring the consignment quantity of the product in the preceding period from the first storage means, the average consumed quantity from the second storage means, the periodic factor index from the third storage means, and the consumption history index from the fourth storage means, calculating a quantity to be consigned in the current period relative to a consignment quantity in the previous period based on the average consumed quantity, the periodic factor index, and the consumption history index, and storing the quantity to be consigned in the current period in the first storage means; and means for outputting the calculated quantity to be consigned in the current period.

Furthermore, in the product consignment quantity setting method of the present invention for setting a consignment quantity of a product that is delivered and consigned to a customer in the field of call sales, a periodic factor index showing a trend of increasing or decreasing quantity of the product consumed in each period and a consignment quantity of the product in each period are stored in advance; a quantity of the product consumed by each customer is input and stored; an average quantity of the product consumed by all customers is calculated from the stored consumed quantity and then stored; a consumption history index showing a quantity of the product that was consumed in each period in the past is calculated from the stored consumed quantity of the product and then stored; a quantity to be consigned in the current period relative to the stored quantity in the previous period is calculated based on the stored average consumed quantity, periodic factor index, and consumption history index, and then stored; and the calculated quantity to be consigned in the current period is output.

As a result of these inventions, by inputting and accumulating the quantity of a product consumed by each customer and by calculating, from the accumulated quantity of product consumed, the average quantity of the product consumed by all customers as well as a consumption history index for the product showing the quantity of the product consumed in respective periods in the past (in each season, for example), and by matching these with a periodic factor index that is set in advance and that shows the trend in the increase or decrease of consumption of the product in the respective periods and calculating the consignment quantity for the current period from the consignment quantity on previous periods, it is possible to set a suitable consignment quantity that is estimated not only from the consumption quantities of a product by each customer, but also from the consumption trends of that product by all customers.

Here, in addition to the consumed quantity of product being input directly from a personal computer or portable input/output terminal, it is also possible to input indirectly by inputting the stock of the product held by the customer and the numerical quantity to be consigned and then transferring the quantity consumed that is calculated based on these.

It is preferable that the periodic factor index is a rate of increase or decrease in the quantity consumed in the same period in the past. As a result of this, it is possible to set an even more appropriate consignment quantity that has been estimated based on also changes in consumption that change with the seasons taken into account using the rate of increase or decrease in the quantity of the product consumed in the same period in the past.

It is also preferable that the consumption history index is a ratio between the cumulative total of the quantity consumed in the past and the total number of periods, namely, the average of the quantity of the product that has been consumed in the past. As a result of this, it is possible to set an even more appropriate consignment quantity that has been estimated based on also long term trends in consumption of the product also taken into account.

The period may be set as a period such as each season or each month; however, it is preferable that the period is the customer's call cycle. As a result of this, by inputting the quantity of the product that has been consumed when the sales person calls on a customer, it is possible to set the quantity to be delivered and consigned to the customer until the next call.

### BRIEF DESCRIPTION OF THE DRAWINGS

FIG. 1 is a schematic view of a business management system used in the field of call sales in an embodiment of the present invention.

FIG. 2 is a block diagram showing the consignment amount setting function of a host computer shown in FIG. 1.

FIG. 3 is a flow chart showing the processing of the business management system of FIG. 1.

FIG. 4 is a diagram showing an example of an output to a portable input/output terminal.

### DESCRIPTION OF THE PREFERRED EMBODIMENTS

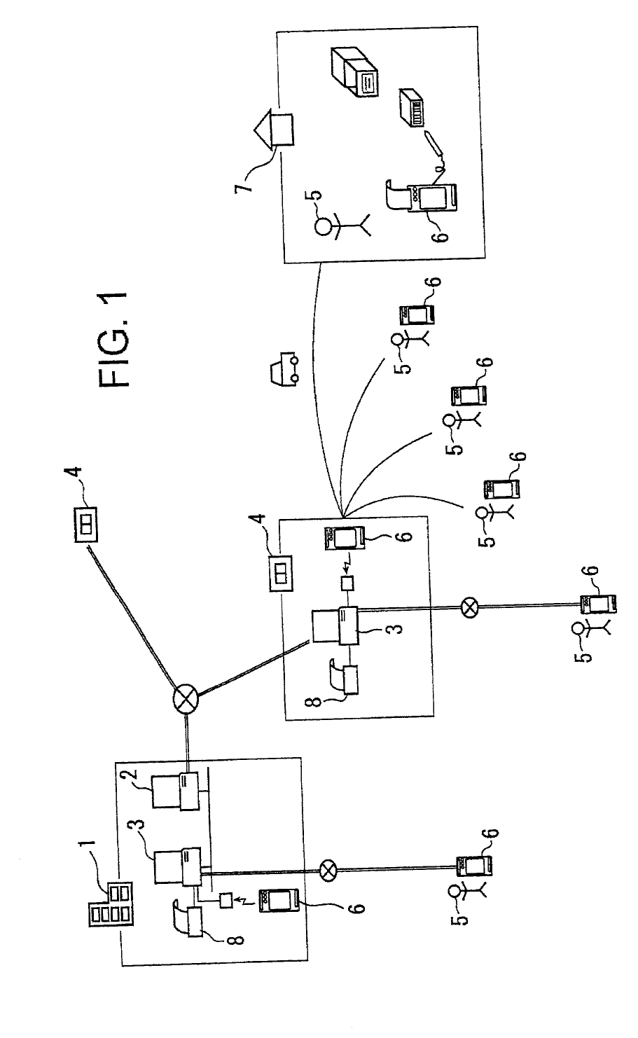

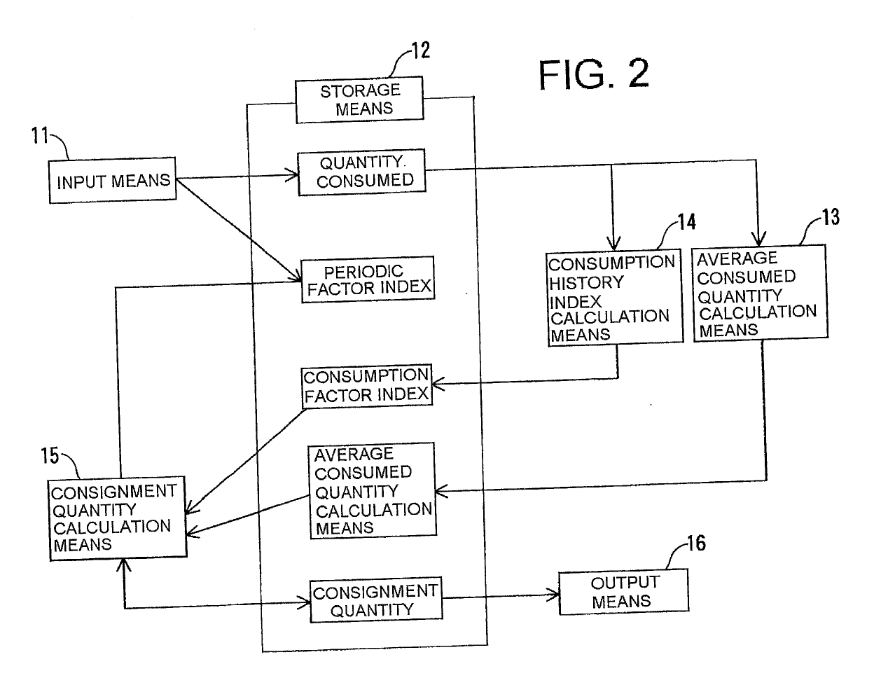

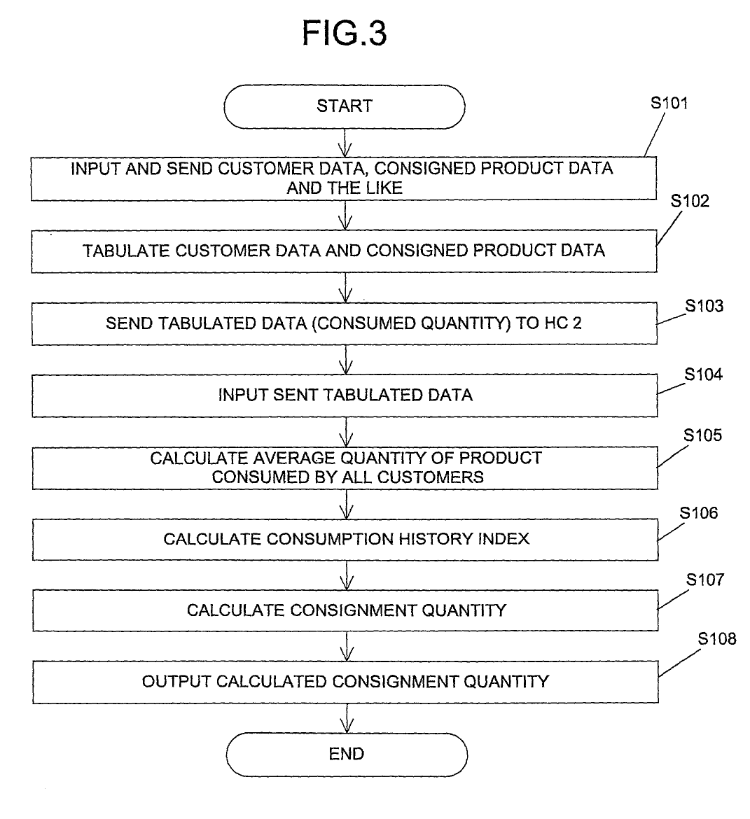

FIG. 1 is a schematic view of a business management system used in the field of call sales in an embodiment of the present invention; FIG. 2 is block diagram showing the consignment amount setting function of a host computer shown in FIG. 1; and FIG. 3 is a flow chart showing the processing of the business management system of FIG. 1.

As is shown in FIG. 1, a host computer (referred to below as “HC”) 2 for data tabulation analysis and a personal computer (referred to below as “PC”) 3 connected to the host computer 2 for data communication are installed in a head office 1. The PC 3 is also installed in each sales office 4 and each sales person 5 carries a portable input/output terminal (referred to below as “HT”) 6.

The salesperson 5 inputs and records on the HT 6 all data relating to a customer 7 serving as the client such as data on the customer and data on the products consigned to that customer. Tabulation analysis is performed when the customer data and consigned product data recorded in the HT 6 are sent to the PC 3. At this time, a telephone line, infrared communication, a PC card, or the like may be used for the means of communication between the HT 6, and the PC 3 and a data file transfer is performed using these means.

The customer data includes an area code, the customer's name, the customer's address, the call cycle, the date of the previous call, the days when the customer stays, the times when the customer stays, a residential map page, the previous credit balance, a record of the sales, the total sales amount, the amount recovered, the current credit balance, the date of the next payment collection, the clinical history, and the like. The consigned product data includes product names, regular prices of the product, product efficacy, names of the manufacturers, selling prices, discount prices, customer stock, limits on the time the product is left with the customer, instructions of consigned product items and quantity, salesperson stock items, salesperson stock numerical quantities, limits on expiry dates, total prices, and the like.

The salesperson 5 calls on the customer in accordance with the call cycle of each customer. When the task of calling on the customer 7 is ended, the salesperson 5 sends the customer data and consigned product data input into the HT 6 to the PC 3 (step S101). When the salesperson 5 is out, the day's transaction data may be transmitted from the HT 6 to the PC 3 by sending the data directly to the PC 3 by PC communication using a telephone line from the HT 6 carried by the salesperson 5. The customer data and consigned product data sent to the PC 3 are tabulated by the PC 3 (step S102), and the tabulated data is sent to the HC 2 (step S103).

In FIG. 2, the HC 2 is provided with an input means 11 for inputting tabulated data sent from the PC 3, a storage means 12 for storing inputted tabulated data and calculation results and the like, an average consumed quantity calculation means 13 for calculating the average quantity of a particular product consumed by all customers based on the tabulated data stored in the storage means 12, a consumption history index calculation means 14 for calculating a consumption history index for a particular product based on the tabulated data stored in the storage means 12, a consignment quantity calculation means 15 for calculating the amount of a product to be consigned based on the results of the calculation and tabulated data stored in the storage means 12 and the like, and an output means 16 for outputting the results of the calculations and tabulated data stored in the storage means 12 and the like to the PC 3 and printer 8 and the like.

The tabulated data sent from the PC 3 is input using the input means 11 and stored in the storage means 12 (step S104). The tabulated data stored in the storage means 12 include the call cycle of a customer and the quantity of each product consumed until a customer is called.

The average consumed quantity calculation means 13 acquires the consumed quantities of each product that are stored in the storage means 12, calculates the average consumed quantity of each product by all customers, and stores the respective calculated average consumed quantities in the storage means 12 (step S105). Examples of the quantity of each product consumed by each customer until the customer is called on and of the average consumed quantity calculated by the average consumed quantity calculation means 13 are shown in Table 1. Here, the average consumed quantity calculation means 13 rounds up decimals of the calculated average consumed quantity to the next whole number.

TABLE 1

| | PRODUCT | PRODUCT | PRODUCT | CALL |
|---|---|---|---|---|
| | A | B | C | CYCLE |
| CUSTOMER X | 1 | 1 | 2 | 3 |
| | | | | MONTHS |
| CUSTOMER Y | 1 | 2 | 2 | 3 |
| | | | | MONTHS |
| CUSTOMER Z | 1 | 3 | 3 | 6 |
| | | | | MONTHS |
| AVERAGE | 1 | 2 | 3 | — |
| QUANTITY | | | | |
| CONSUMED | | | | |

A periodic factor index showing the trend of the increase or decrease in the quantity of consumption of each product per period is stored in advance in the storage means 12. In the present embodiment, the period is the call cycle at which the salesperson 5 calls on the customer and the periodic factor index at this time is shown as a rate of increase or decrease determined from the quantity of each product consumed in the same period of previous years. For example, if the call cycle for a customer is 3 months and the current visit is in Jun., the periodic factor index is found by dividing the quantity consumed at the time of the Sep. call of the previous year by the quantity consumed at the time of the Jun. call of the previous year. Examples of the periodic factor index and the quantity consumed of a particular product for respective past periods are shown in Table 2.

TABLE 2

| PERIOD | OCT-DEC | JAN-MAR | APR-JUN | JUL-SEP |
|---|---|---|---|---|
| QUANTITY | 4 | 2 | 1 | 4 |
| CONSUMED | | | | |
| PERIODIC | 0.5 | 0.5 | 4.0 | 1.0 |
| FACTOR | | | | |
| INDEX | | | | |

The consumption history index calculation means 14 acquires the quantity of each product consumed by each customer from the storage means 12 and calculates a consumption history index showing the quantities of those products consumed in each period in the past. The calculated consumption history index is then stored in the storage means 12 (step S106). The consumption history index is determined from the ratio of the sum quantity of the product consumed in the past to the total number of periods, namely, from the average of the quantity of the product consumed in the past. For example, if the sum quantity of a particular product consumed by a particular customer is a, if the number of the periods needed for consuming the product a is b, and if the quantity consumed in the previous period is c, then the average of the quantity of the product consumed in the past is a/b. The consumption history index at this time is found by c/(a/b). When c=0, then c is taken as =1.

The consignment quantity calculation means 15 acquires the quantity of a particular product consigned for the previous period (in the present embodiment this is the time of the previous call) from the storage means 12 as well as the average quantity consumed, the periodic factor index, and the consumption history index and calculates the consignment quantity for the current period from the consignment quantity for the previous period using the following formula. The calculated consignment quantity is then stored in the storage means 12 (step S107).

current consignment quantity=previous consignment quantity×average quantity consumed×periodic factor index ×consumption history index

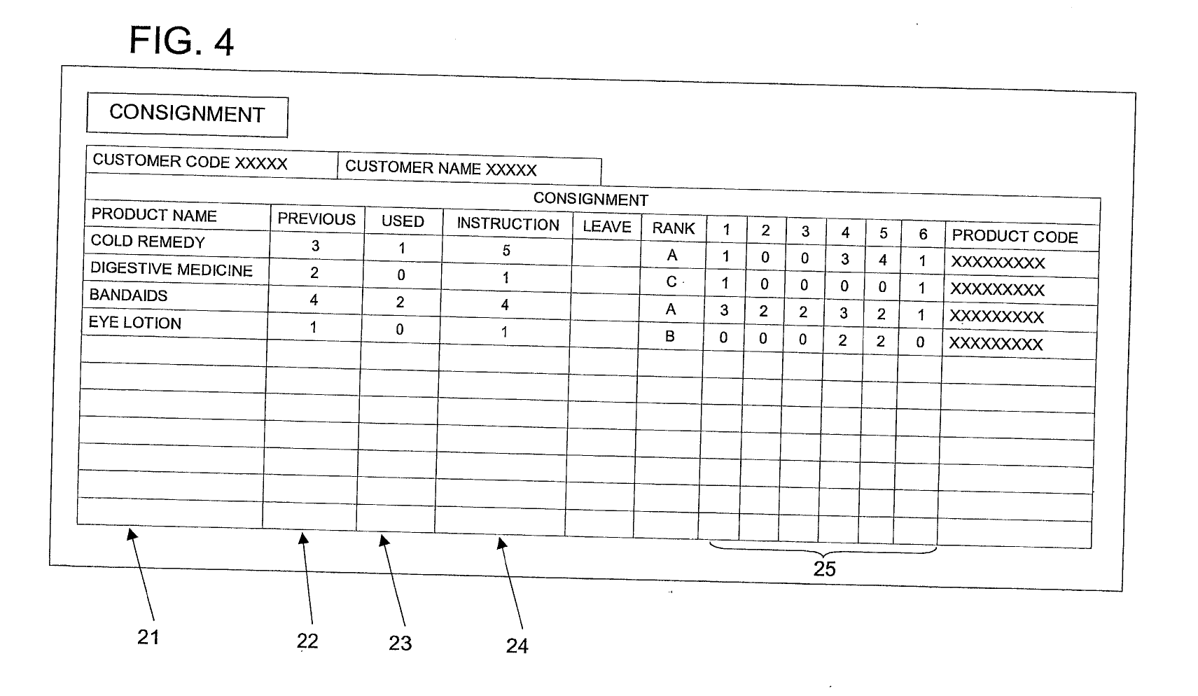

FIG. 4 shows an example where a current consignment quantity calculated by the consignment quantity calculation means 15 is output to the HT 6 by the output means 16 (step S108)

As is shown in FIG. 4, a product name 21, a quantity consigned for the previous period 22, a quantity consumed in the previous period 23, and a consignment quantity for the current period 24 for each product are displayed on the HT 6. On the right side thereof is displayed the consumed quantity history 25 of each product up to two periods before.

As described above, based on the call cycle, by inputting the quantities of each product consumed at the time a salesperson calls on a customer into the HT 6 on each occasion and sending them to the PC 3 and HC 2 and inputting and accumulating them, and by calculating both the average quantity consumed by all customers of the products and the consumption history index for the products from these accumulated quantities of product consumed and matching them with a periodic factor index set in advance and by then calculating the consignment quantity for the current period from the consignment quantity for previous periods, it is possible to set a suitable consignment quantity that is estimated not only from the consumption quantities of a product by each customer, but also from the consumption trends of that product by all customers and that does not rely on the intuition and experience of the salesperson.

Moreover, in the present embodiment, by adding a periodic factor index determined from the rate of increase or decrease in the quantity consumed in the same period in the past to the consignment quantity parameters, it is possible to obtain an even more appropriate consignment quantity for products such as those whose consumption quantities tend to change with the seasons such as between summer and winter. Furthermore, by adding a consumption history index determined from the average of past quantities of a product consumed to the consignment quantity parameters, it is possible to obtain an even more appropriate consignment quantity that has estimated based on also long term trends in consumption of the product.

While the preferred form of the present invention has been described, it is to be understood that modifications will be apparent to those skilled in the art without departing from the spirit of the invention. The scope of the invention, therefore, is to be determined solely by the following claims.

What is claimed is:

1. A consignment quantity setting device for setting a consignment quantity of a product that is delivered and consigned to a customer in the field of call sales comprising:
means for inputting a quantity of the product that is consumed by the customer;
first storage means for storing the input consumed quantity of the product and a consignment quantity of the product in each period;
means for acquiring the consumed quantity of the product from the first storage means and calculating an average quantity of the product consumed by all customers;
second storage means for storing the calculated average consumed quantity;
third storage means for storing a periodic factor index showing a trend of increasing or decreasing quantity of the product consumed in each period;
means for acquiring the consumed quantity of the product from the first storage means and calculating a consumption history index showing a quantity of the product that was consumed in each period in the past;
fourth storage means for storing the calculated consumption history index;
means for acquiring the consignment quantity of the product for the preceding period from the first storage means, the average consumed quantity from the second storage means, the periodic factor index from the third storage means, and the consumption history index from the fourth storage means, calculating a quantity to be consigned for the current period relative to the previous period based on the average consumed quantity, the periodic factor index, and the consumption history index and storing the quantity to be consigned for the current period in the first storage means; and
means for outputting the calculated quantity to be consigned for the current period.

2. The consignment quantity setting device according to claim 1, wherein the periodic factor index is a rate of increase or decrease in a quantity consumed compared to the same period in the past.

3. The consignment quantity setting device according to claim 1 or 2, wherein the consumption history index is a ratio of a cumulative total of a quantity consumed in the past to a total number of periods.

4. The consignment quantity setting device according to any of claim 1, wherein the period is the call cycle to the customer.

5. A consignment quantity setting method for setting a consignment quantity of a product that is delivered and consigned to a customer in the field of call sales, wherein:
a periodic factor index showing a trend of increasing or decreasing quantity of the product consumed in each period and a consignment quantity of the product for each period are stored in advance;
a quantity of the product consumed by each customer is input and stored;
an average quantity of the product consumed by all customers is calculated from the stored consumed quantity and then stored;
a consumption history index showing a quantity of the product that was consumed in each period in the past is calculated from the stored consumed quantity of the product and then stored;
a quantity to be consigned for the current period relative to the stored quantity in the previous period is calculated based on the stored average consumed quantity, periodic factor index, and consumption history index and then stored; and
the calculated quantity to be consigned for the current period is output.
